(19) United States
(12) Patent Application Publication
(10) Pub. No.: US 2010/0125497 A1
(43) Pub. Date: May 20, 2010

(54) ELECTRONIC COUPON DISTRIBUTION AND REDEMPTION METHOD FOR ELECTRONIC DEVICES

(76) Inventor: Dale Junior Arguello, Scottsdale, AZ (US)

Correspondence Address: SCHMEISER OLSEN & WATTS, 18 E UNIVERSITY DRIVE, SUITE # 101, MESA, AZ, 85201, US

(21) Appl. No.: 12/388,351

(22) Filed: Feb. 18, 2009

Related U.S. Application Data
(60) Provisional application No. 61/122,995, filed on Dec. 16, 2008.

(51) Int. Cl. G06Q 30/00; G06F 17/30

(52) U.S. Cl. 705/14.33; 707/E17.108

(57) ABSTRACT

A coupon redemption system includes a web application server having a database corresponding with information regarding a coupon. An electronic device is in communication with the web application server through a data communication network. The electronic device displays a barcode image corresponding to the coupon information. The bar code image is adjustable in response to an indication of the type of electronic device.

### CROSS-REFERENCE TO RELATED APPLICATIONS

This application claims priority to U.S. Provisional Application No. 61/122,995, filed on Dec. 16, 2008, the contents of which are incorporated herein by reference.

### BACKGROUND OF THE INVENTION

1. Field of the Invention

This invention relates generally to a system and method of distributing, displaying, and redeeming an electronic coupon through the use of a mobile device.

2. Description of the Related Art

Many retailers utilize coupons to attract customers. A typical coupon includes a variety of different types of indicia, such as a bar code as well as a corresponding Universal Product Code (UPC Code). The bar code can be read by a scanning device, such as a bar code reader. More information regarding scanning devices, UPC codes and bar code readers can be found in U.S. Pat. Nos. 5,780,832, 5,689,103, 5,537,431, 5,440,110, 4,963,719 and 5,311,000, the contents of all of which are incorporated herein by reference.

Most coupons are provided in hardcopy form, wherein the indicia is printed on paper. For example, the bar code and UPC code are typically printed on the paper. However, printing a large number of coupons on paper uses a large amount of resources, and leads to waste if the coupons are not used.

Other coupons can be displayed as a softcopy image on the screen of an electronic device. The electronic device can be of many different types; examples include mobile phones, personal digital assistants (PDA), and other mobile devices, which have a display screen. A softcopy of the coupon eliminates the need to print it on paper, which reduces the amount of resources used, as well as the amount of waste. More information regarding systems and methods which utilize coupons in softcopy form can be found in U.S. Pat. Nos. 5,930,767, 7,343,319, as well as in U.S. Patent Application Nos. 20020004746, 20020040316, 20020042774, 20020055906, 20020060246, 20020161640, 20020161708, 20040024638 and 20080270243, the contents of all of which are incorporated herein by reference.

As businesses strive to increase efficiencies, reduce waste, and better market to their customers they turn to the use of electronic media and services to replace their old paper based marketing strategies. Given these conditions the need and desire becomes apparent for businesses to be able to scan a softcopy of a coupon with the scanning device, such as the bar code reader directly from the screen of a mobile device.

It is known that, in general, different electronic devices have display screens with different resolutions. It is also known that the accuracy of the scanning device depends on the resolution of the bar code that is displayed. Hence, if a softcopy of the bar code is displayed with a resolution that is too low, the scanner may have difficulty reading it. Thus, what is needed is a system and method for displaying a softcopy of a bar code so that the scanning device is more likely to be able to read the bar code.

### BRIEF SUMMARY OF THE INVENTION

The present invention provides a coupon redemption system, which includes a web application server having a database corresponding with information regarding a coupon. The coupon redemption system includes a data communication network. The coupon redemption system includes an electronic device in communication with the web application server through the data communication network, wherein the electronic device displays a barcode image corresponding to the coupon information, the bar code image being adjustable in response to an indication of the type of electronic device.

The coupon redemption system provides many other features. For example, in some embodiments, the bar code image is adjustable in response to a display resolution of the electronic device. In some embodiments, the bar code image is adjustable in response to a screen size of the electronic device. In some embodiments, a dimension of a bar of the bar code image is driven to be equal to or greater than about 3 mils. In some embodiments, a dimension of the bar code image is driven to equal the dimension of a display screen of the electronic device. In some embodiments, the web application server selects the coupon in response to an indication of the geographical location of the electronic device.

The present invention employs a method of displaying an image with a display screen of an electronic device. The method includes establishing communication between the electronic device and a web application server, wherein the web application server is in communication with a database of information corresponding to a coupon. The method includes flowing the information corresponding to the coupon to the electronic device, wherein a barcode image associated with the coupon is displayed by the display screen. The barcode image is adjusted in response to an indication of a characteristic of the electronic device.

The method can provide many other features. For example, in some embodiments, the characteristic of the electronic device corresponds to the resolution of its display screen. In some embodiments, the characteristic of the electronic device corresponds to the size of the display screen.

The method can include many other steps. For example, in some embodiments, the method includes determining the barcode information with a scanning device. In some embodiments, the method includes selecting, with the web application server, the coupon in response to an indication of the geographical location of the electronic device. In some embodiments, the method includes adjusting the bar code image in response to driving a dimension of a bar of the bar code image to be equal to or greater than about 3 mils. In some embodiments, the method includes adjusting the bar code image in response to driving a dimension of the bar code image to equal a dimension of the display screen.

The present invention employs a method of displaying an image with a display screen of an electronic device. The method includes establishing communication between the electronic device and a web application server, wherein the web application server is in communication with a database of a plurality of coupons. The method includes selecting a desired coupon of the database and determining the type of electronic device. The method includes flowing the information corresponding to the desired coupon to the electronic device, wherein a barcode image associated with the desired coupon is displayed by the display screen, the barcode image being adjusted in response to the type of electronic device.

The method can provide many other features. In some embodiments, the characteristic of the display screen is the resolution of the display screen. In some embodiments, the characteristic of the display screen is the size of the display screen.

The method can include many other steps. For example, in some embodiments, the method includes operating a local application with the electronic device, wherein the local application communicates with the web application and database server for coupon information. In some embodiments, the step of selecting the desired coupon includes determining the geographical location of the electronic device. In some embodiments, the step of determining the geographical location of the electronic device includes using a Global Positioning System (GPS). In some embodiments, the step of determining the type of electronic device includes determining a characteristic of its display screen.

These and other features, aspects, and advantages of the present invention will become better understood with reference to the following drawings and description.

### BRIEF DESCRIPTION OF THE DRAWINGS

FIGS. 1a and 1b are front and back views, respectively, of an electronic device displaying a bar code image with a display screen.

FIG. 1c is a top view of the bar code image of FIG. 1a.

FIG. 1d is a top view of the display screen of FIG. 1a.

FIG. 1e is a back view of the electronic device of FIGS. 1a and 1b imaging a bar code with a camera.

FIG. 2 is a diagram of a web-application based coupon redemption system, in accordance with the invention.

FIG. 3 is a diagram of a coupon redemption system, in accordance with the invention.

FIG. 4 is a diagram of a local-application based coupon redemption system, in accordance with the invention.

FIG. 5 is a diagram of a geographical location, which includes a number of stores, wherein a product can be located within the geographical location by using a local-application based coupon redemption system.

FIGS. 6, 7 and 8 are flow diagrams of methods, in accordance with the invention, of displaying an image with a display screen of an electronic device.

FIG. 9 is a method, in accordance with the invention, of determining a store in which a coupon is redeemable.

### DETAILED DESCRIPTION OF THE INVENTION

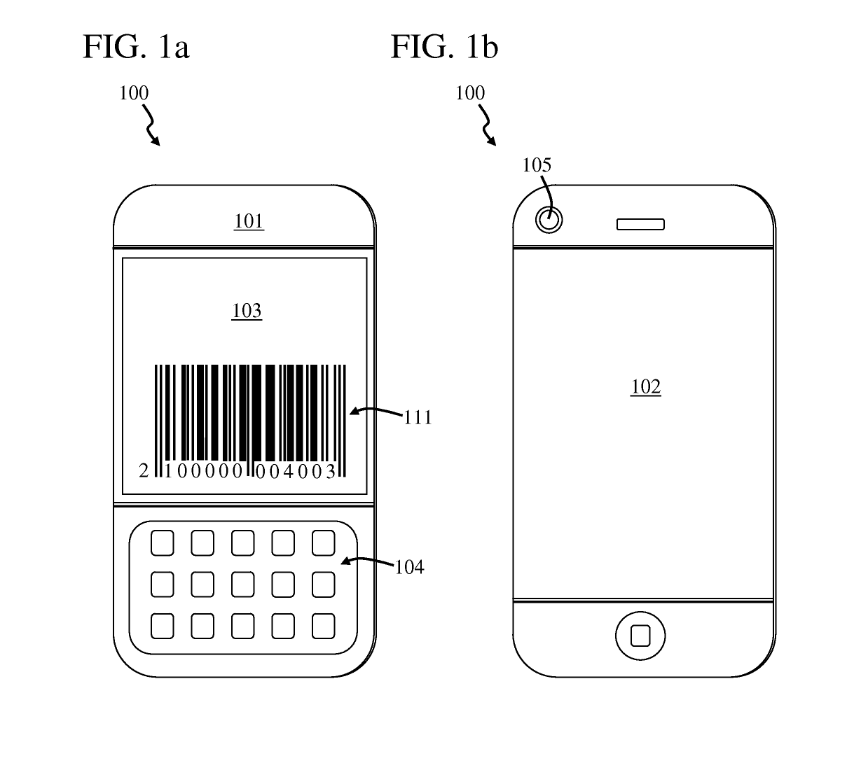

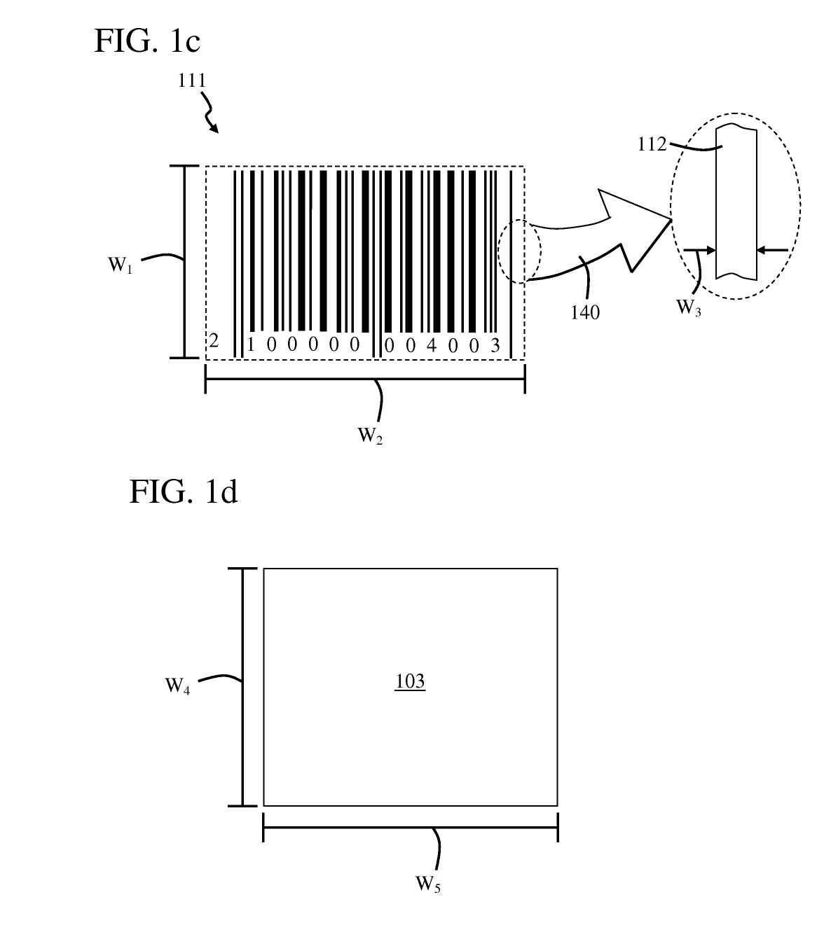

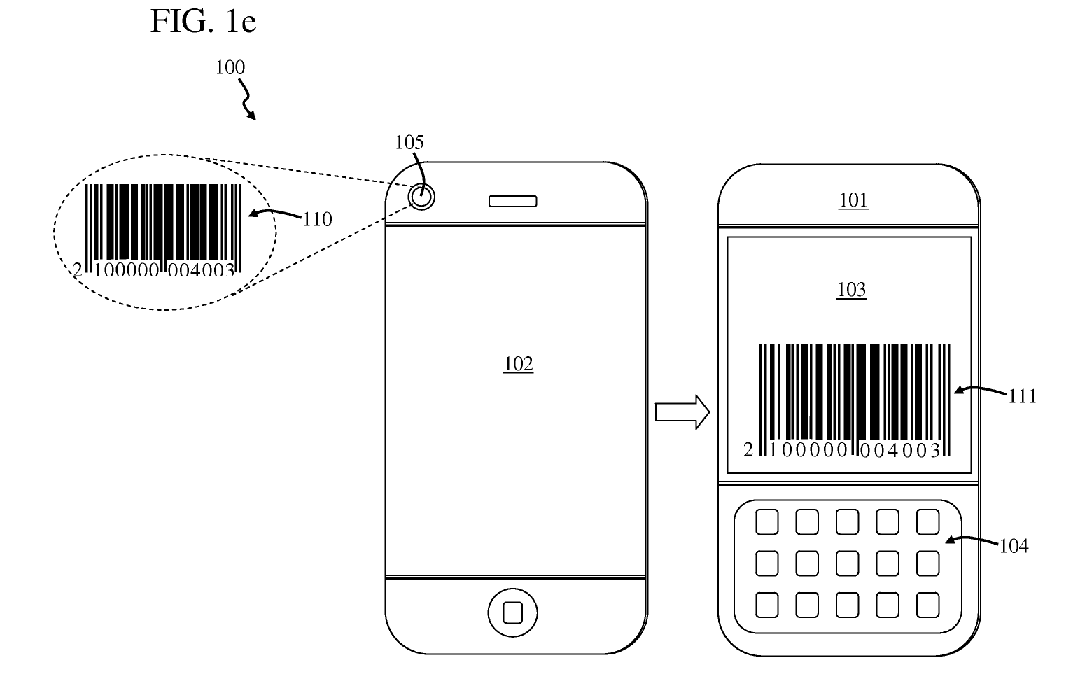

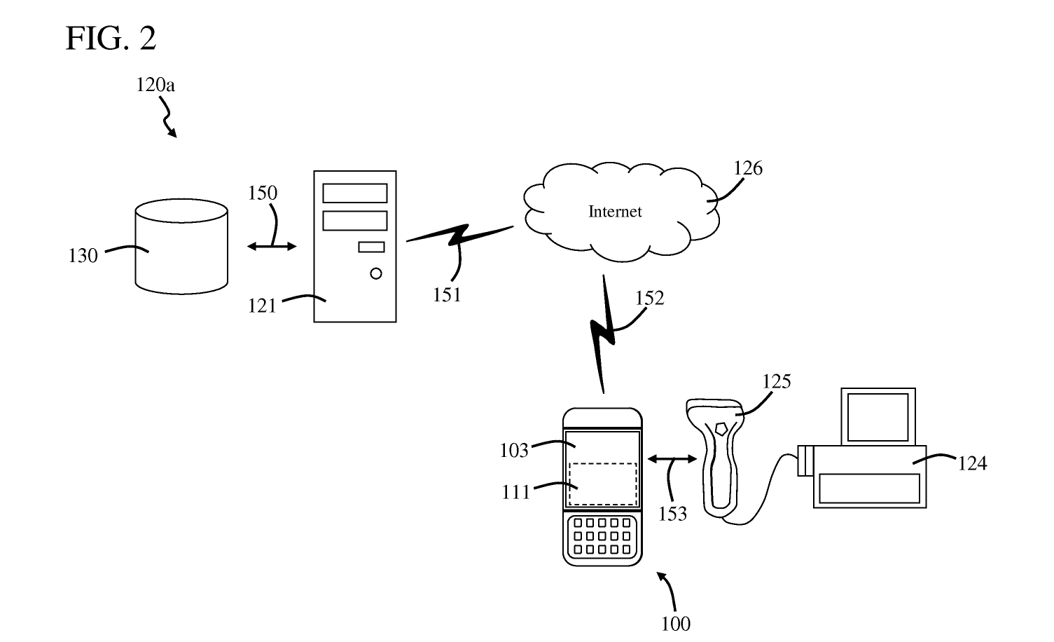

FIGS. 1a and 1b are front and back views, respectively, of an electronic device 100. In this embodiment, electronic device 100 includes a display screen 103 at its front side 101 and a camera 105 at its backside 102, wherein display screen 103 is displaying a bar code image 111. Further, electronic device 100 includes a key pad 104 at its front side. Display screen 103 displays indicia in response to activating key pad 104 in a well-known manner.

Electronic device 100 can be of many different types, but it generally provides the ability to communicate with a communication network, such as the Internet. The communication between electronic device 100 and the communication network is typically wireless communication. Examples of electronic devices having display screens include cell phones and hand-held computers. Examples of cell phones having display screens include the IPHONE and BLACKBERRY. Examples of hand-held computers include personal digital assistants (PDA), such as a PALM PILOT. These types of electronic devices are provided with a display screen that has a predetermined size and resolution. Bar code image 111 can be in many different file formats, such as portable network graphics (PNG), joint photography experts group (JPG), tagged image file format (TIFF), bitmap (BMP) and graphics interchange format (GIF). Bar code image 111 corresponds with a digital file representation of a bar code, such as the bar codes discussed in more detail above in the background of this application.

FIG. 1c is a top view of bar code image 111 of FIG. 1a, and FIG. 1d is a top view of display screen 103 of FIG. 1a. In this embodiment, bar code image 111 is rectangular in shape and has dimensions W₁ and W₂. Bar code image 111 generally includes a plurality of bars, one of which is indicated by an indication arrow 140 and denoted as bar 112. Bar 112 has a dimension W₃ which corresponds with its width. The width of bar 112 is less than its length.

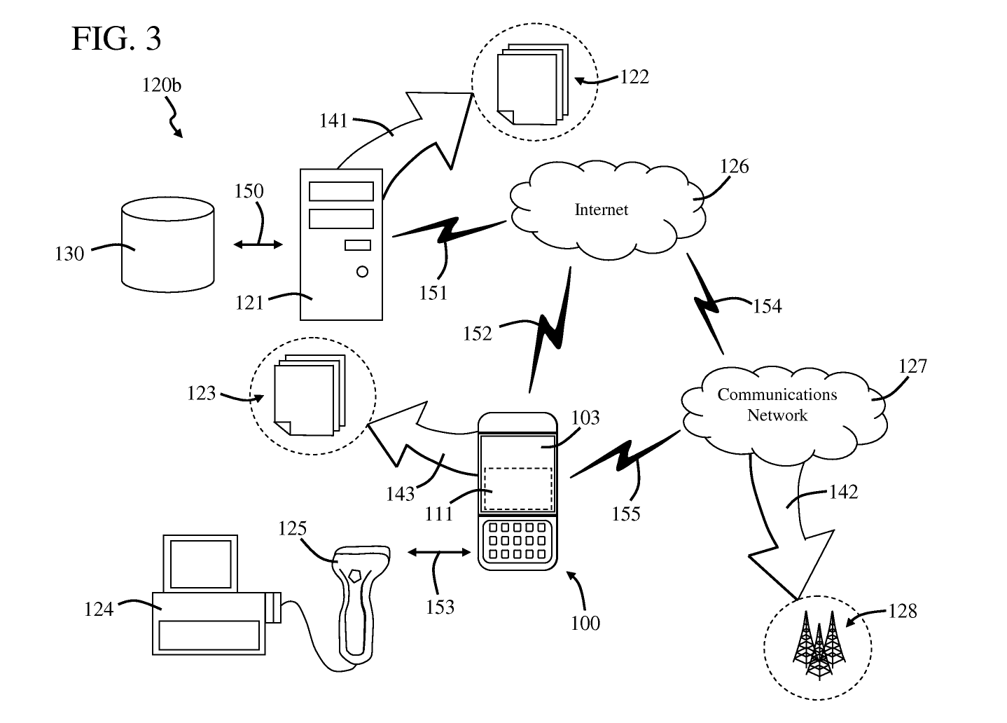

Bar code image 111 can also include indicia, such as letters and numbers, if desired, as well as the patterns, such as two-dimensional barcodes. Bar code image 111 includes indicia so that the coupon can be used without reading bar code image 111 with a scanning device, such as a bar code reader. In this way, the coupon can be used manually or verbally. In a typical situation, bar code 110 is imaged using camera 105, as shown in FIG. 1e, and bar code image 111 is provided in response and displayed by display screen 103. Bar code image 111, along with its corresponding indicia, is displayed by display screen 103 and the indicia are entered manually into a point of sale system, such as a computer system or cash register. If desired, bar code image 111 can be printed out by the point of sale system. Image scanning redemption refers to physically presenting electronic device 100, with barcode image 111 displayed by display screen 103, to a merchant point of sale (i.e. a store), and using a barcode reader to read barcode image 111 directly from display screen 103. More information regarding these two redemption methods is provided below with FIG. 2.

In this embodiment, display screen 103 is rectangular in shape and has dimensions W₄ and W₅. It should be noted that dimension W₁ is less than dimension W₄, and dimension W₅ is less than dimension W₅. Dimension W₁ is less than dimension W₄ and dimension W₅ is less than dimension W₅ so that the size of bar code image 111 is less than the size of display screen 103.

In this embodiment, bar code image 111 is adjustable in response to an indication of the type of electronic device. For example, in some situations, bar code image 111 is adjusted in response to an indication of the manufacturer of electronic device 100. In some situations, bar code image 111 is adjusted in response to an indication of the manufacturer of display screen 103. Bar code image 111 is adjustable in response to an indication of the type of electronic device so that bar code image 111 can be more easily read with a bar code reader.

Further, in this embodiment, bar code image 111 is adjusted in response to an indication of a characteristic of the electronic device. For example, in some situations, bar code image 111 is adjustable in response to a display resolution of electronic device 100. In particular, bar code image 111 is adjustable in response to a display resolution of display screen 103. In one example, the resolution of bar code image 111 is increased in response to determining the display resolution of display screen 103. The resolution of bar code image 111 is increased to reduce the amount of pixilation it experiences. Bar code image 111 is adjusted in response to a display resolution of electronic device 100 so that bar code image 111 can be more easily read with a bar code reader.

In some situations, bar code image 111 is adjustable in response to a screen size of electronic device 100. In particular, bar code image 111 is adjustable in response to a screen size of display screen 103. For example, in some embodiments, bar code image 111 is adjusted so that dimension W₁ is driven to equal dimension W₄. In general, bar code image 111 is adjusted so that the difference between dimensions W₁ and W₄ is decreased. Further, in some embodiments, bar code image 111 is adjusted so that dimension W₂ is driven to equal dimension W₅. In general, bar code image 111 is adjusted so that the difference between dimensions W₂ and W₅ is decreased. Bar code image 111 is adjustable in response to a screen size of electronic device 100 so that bar code image 111 can be more easily read with a bar code reader. Dimensions W₁ and W₂ can be adjusted in many different ways, such as by adjusting the magnification of bar code image 111. More information regarding the magnification of bar code image 111 is provided in the above-referenced provisional application.

In some situations, dimension W₃ of bar 112 is driven to be a desired dimension value. For example, in some situations, dimension W₃ of bar 112 is driven to be equal to or greater than about 3 mils. In this way, a dimension of bar 112 of bar code image 111 is driven to be equal to or greater than about 3 mils. In some embodiments, dimension W₃ of bar 112 is driven to be between about 3 mils and 15 mils. It should be noted that display screens currently available can display a bar code image having dimension W₃ equal to about 13 mils. However, it is anticipated that display screens will be developed that are able to display a bar code image having dimension W₃ less than 13 mils.

In general, the imaging requirements for displaying a softcopy of a bar code are as follows. At a minimum, one barcode image will be sized and displayed for redemption by display screen 103. Barcode images should be displayed at a resolution such that there is a distinguishable break between adjacent bars or in the pattern symbology. It is desirable for the magnification factor to be such that the barcodes X-Dimension is displayed at a size greater than or equal to about 3 mils (i.e. 3/1000 of an inch). This is because, for most scanning devices, the anticipated smallest supported X-Dimension is 3 mils or 3/1000 of an inch. The X-Dimension is the measurement of the narrowest bar in a barcode (i.e. width W₃). Width W₃ is generally measured in mils, wherein 1 mil= 1/1000th of an inch. The Magnification Factor is the stretch, skew, or zoom of an image measured in percentage. An image at true size is to be at 100% Magnification Factor. More information regarding the Magnification Factor is provided in the above-referenced provisional application.

The physical Width/Height of bar code image 111 is dependant on the barcode encoding type and electronic devices operating system, display screen size, and display screen resolution, among other factors. Bar code image 111 should be displayed by display screen 103 in such a way that the full image is visible so that the bar code reader can read bar code image 111. Further, bar code image 111 should be displayed by display screen 103 in such a way as to maintain the integrity of bar code image 111 and reduce the amount of breaks and/or pixilation in the bars of bar code image 111.

There are many different barcode types that are currently used. These barcode types are generally categorized as being 1-dimensional and 2-dimensional types. Examples of 1-dimensional and 2-dimensional types are provided as follows:

### Examples of Bar Code Types:

| 1 Dimensional Types: | 2 Dimensional Types: |
|---|---|
| Codabar | Data Matrix |
| Code 128 | PDF 417 |
| Code 25 | Micro PDF 417 |
| Code 39 | Samsung PDF 417 |
| Code 93 | RSS 14 |
| EAN 128 | RSS Expanded |
| EAN 13 | RSS Limited |
| EAN | |
| JAN | |
| Plessey | |
| Telepen | |
| UPC A | |
| UPC E | |

There are many different scanning devices that are currently used to scan barcodes. These scanning devices are provided as follows:

Examples of Compatible Barcode Reader Types:

Charged Couple Device (CCD)

Linear Imager

Long Range CCD

Area Imager

Video Imager

FIG. 2 is a diagram of a web-based coupon redemption system 120a, in accordance with the invention. In this embodiment, coupon redemption system 120a includes electronic device 100 in communication with Internet 126 through a communication channel 152. In this embodiment, Internet 126 is in communication with a web application server 121 through a communication channel 151. In this embodiment, web application server 121 is in communication with a coupon database 130 through a communication channel 150. Coupon database 130 includes a database of coupon information for various products. In general, a user of the coupon information is capable of acquiring a product for less consideration. In this way, web application server 121 includes a coupon database 130 corresponding with information regarding a coupon. Electronic device 100 displays a bar code image 111 corresponding to the coupon information. Bar code image 111 is adjustable in response to an indication of the type of electronic device.

In this embodiment, coupon redemption system 120a includes a point of sale system 124 in communication with a bar code reader 125. Bar code reader 125 is capable of reading bar code image 111 displayed by display screen 103 of electronic device 100. The ability of bar code reader 125 to read bar code image 111 is represented by a communication channel 153. In general, communication channel 153 is an optical communication channel because bar code image 111 is typically read with a light signal provided by bar code reader 125. In some situations, bar code reader 125 reads bar code image 111 by flowing an optical signal, such as from a laser, to bar code image 111. In other situations, bar code reader 125 reads bar code image 111 by receiving an optical signal, such as by using a camera, to image bar code image 111.

Coupon redemption system 120a distributes a softcopy of the coupon to a desired electronic device, such as electronic device 100. Coupon redemption system 120a generally includes one or more computers in communication with each other, as well as Internet 126 (i.e. the Web). It should be noted that the Internet includes a data communication network which allows the transmission of data from one computer to another, wherein the data is typically in digital form. The computer(s) are also in communication with the electronic device through the internet. The computer(s) have access to coupon database 130 which includes information regarding the coupon. The information regarding the coupon is typically stored in a flat file. Information in the flat file is generally separated. For example, the information can be tab delimited or comma delimited, if desired. The information corresponds to many different characteristics of the coupon, such as the product and/or service it is identified with, the coupon value, the coupon expiration date, etc. The product the coupon is identified with can be of many different types, such as a grocery product (i.e. milk) and clothing merchandise (i.e. a shirt). The service the coupon is identified with can be of many different types, such as a haircut or carwash. The coupon's discount value corresponds to the reduction in purchase price which the coupon holder receives when purchasing the identified product or service. The coupon expiration date is the date at which the coupon expires and is no longer redeemable.

In operation, the information corresponding to one or more coupons is entered into coupon database 130. The information corresponding to the coupon(s) can be entered into coupon database 130 in many different ways, such as by flowing the information of the flat file to coupon database 130 through web application server 121. Web application server 121 is typically run on the computer(s) mentioned above. Web application server 121 can validate the flat file by processing and checking the flat files data structure prior to integrating the information into coupon database 130. After the flat files data structure has been validated, the flat files coupon feed is then incorporated into coupon database 130.

It should be noted that the coupon expiration date is generally included as part of the flat files record and is used to age and expire a coupon. It should also be noted that only coupons with designated future expiration dates, as compared to the web applications system date, will be available for end user viewing and use. In this way, coupons that have expired will not be available for redemption.

In operation, a user will typically be required to establish an account with web application server 121 prior to being able to use any active coupons. The account includes information regarding the user, such as a name and contact information. Examples of contact information include the user's address, phone number, e-mail address, etc. The process of establishing the account is typically referred to as registration. Web application server 121 allows the user to view and select coupons in response to establishing the account, as described above.

It is desirable to require the user to establish an account so that his or her habits can be tracked. For example, the type and amount of coupons that the user redeems can be tracked. It is desirable to track the type and amount of coupons redeemed by the user to reduce the user's ability to abuse the coupon redemption system and for marketing purposes. For example, it is desirable to track the type and amount of coupons redeemed by the user to reduce the user's ability to redeem multiple coupons for the same product. User site actions including keyword search, browse, and viewing histories are logged and tracked for reporting and marketing purposes.

In some embodiments, coupon viewing is tracked and limited based on unique user profiles. For example, the user profile can have a coupon view number associated with it. Once the user has viewed a number of coupons corresponding to the coupon view number, his or her ability to view more coupons is restricted. For example, in some situations, the user's ability to view coupons associated with milk is restricted in response to the user viewing five coupons corresponding with milk. In this example, the coupon view number corresponds with five. It should be noted that the coupon view number can have many different number values, and generally has a number value in a range greater than or equal to zero.

Web application server 121 typically determines and establishes the coupon view number. However, in some embodiments, the user can request to view a coupon through the use of a web enabled mobile device or a Personal Computer (PC). A user request to view an active useable coupon can be processed in many different ways. In one embodiment, the user request to view an active useable coupon is processed as follows. A coupon to be viewed is selected by a user. Web application server 121 processes the request by checking to see how to handle the request. If the database has an ASCII coupon code, the text will be pulled into the web application server for the users display and use. If coupon database 130 has a barcode type selected, a script will be used to translate the requested coupon into a viewable barcode image file corresponding with bar code image 111. The barcode image file is stored locally in a temporary location on web application server 121. The user is presented coupon barcode image 111 through web application server 121 referencing the temporary image location. The web application server 121 appropriately sizes barcode image 111 based on the user's environmental variables including web browser and operating system of electronic device 100, if applicable.

In accordance with the invention, bar code image 111 will be displayed by display screen 103 in such a way that it conforms to the specifications discussed above. In particular, the size and resolution of bar code image 111 is adjusted in response to an indication of the type of display screen 103 included with electronic device 100 so that bar code image 111 can be displayed in a manner in which it can be read by the scanning device. The indication of the type of display screen is generally a signal which is flowed from electronic device 100 to web application server 121.

There are many different ways and image format types in which the barcode image can be displayed with the display screen. Examples of some ways and image format types include Image File Format, Vector Graphics, Metafile, and Page Description Language. The way in which bar code image 111 is displayed by display screen 103 depends on many different factors, such as the type of electronic device 100, the type of display screen 103, as well as the operating system of electronic device 100.

In some embodiments, after a set duration of time, the file corresponding to barcode image 111 is deleted from the temporary storage location on web application server 121 and is no longer available for use. In some embodiments, after a set duration of time, barcode image 111 is deleted from coupon database 130 and is no longer available for use. In some embodiments, after a set duration of time, barcode image 111 is deleted from electronic device 100 and is no longer available for use. Deleting barcode image 111 from electronic device 100 is useful so that the user is restricted from abusing the coupon redemption system by using the coupon multiple times.

As mentioned above, there are many different methods for redeeming the coupon. One method for redeeming the coupon is referred to as image scanning redemption. Image scanning redemption refers to physically presenting the electronic device, with the barcode image rendered on the display screen, to a merchant point of sale (POS) system and using the merchant's barcode scanner to read the displayed barcode image from the display screen. For example, in some situations, the bar code image is redeemed by reading the barcode image from the display screen using the scanning device, wherein the scanning device is in communication with the POS system. Examples of POS systems are disclosed in some of the references mentioned above. Other examples of POS systems can be found in U.S. Pat. Nos. 7,406,438, 5,179,375, 4,937,744, 4,734,857, 4,204,636, the contents of all of which are incorporated herein by reference.

Another method for redeeming the coupon is referred to as manual Key/Verbal redemption. Manual Key/Verbal redemption refers to physically presenting the display screen or coupon print outs to a merchant point of sale system and manually having the numeric or ASCII characters keyed into the POS system. For example, in some situations, the coupon is redeemed by reading the UPC code from the display screen and entering the code into a Point of Sale (POS) system. Examples of POS systems include a cash register and a computer that operates as a cash register. Redeeming the coupon by reading the UPC code from the display screen and entering the code into the POS system is useful if the barcode image cannot be read by the scanning device.

It should be noted that coupon redemption system 120a, as described above, is a web-application based coupon redemption system because it utilizes web application server 121. In other embodiments, however, the coupon redemption system is a local-application based coupon redemption system, wherein electronic device 100 operates a local application and communicates with a web application server. An example of a local-application based coupon redemption system will be discussed in more detail presently.

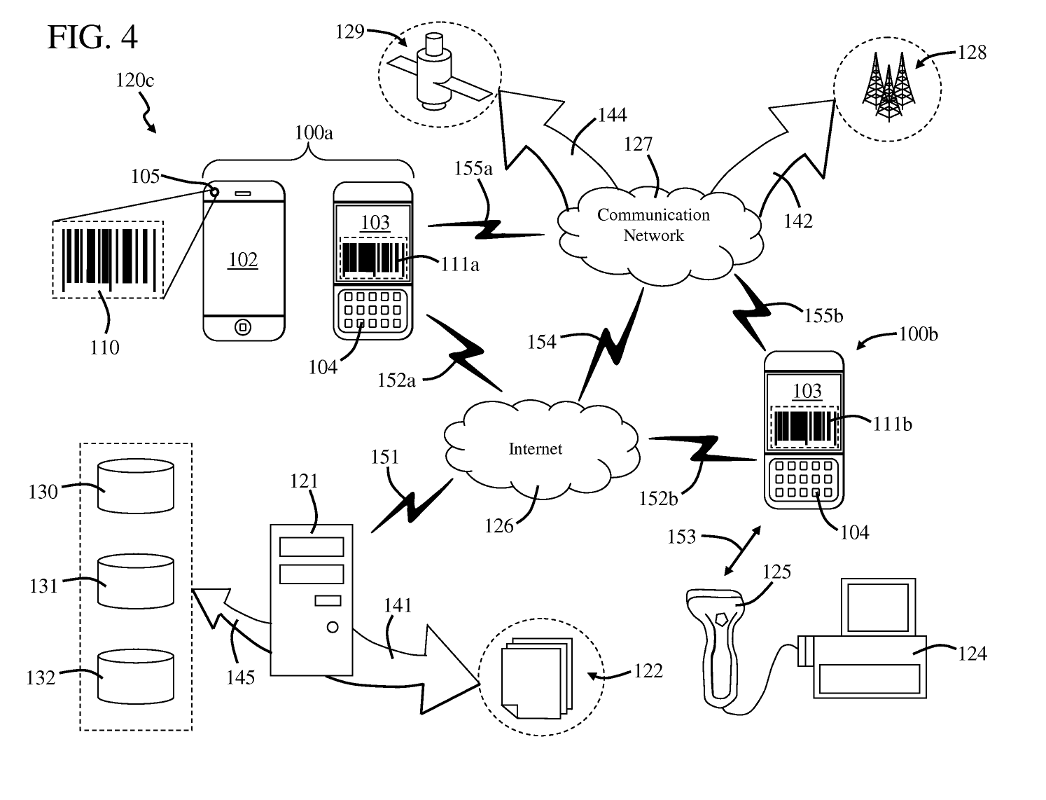

FIG. 3 is a diagram of a local-application based coupon redemption system 120b, in accordance with the invention. In this embodiment, local-application based coupon redemption system 120b includes electronic device 100 in communication with Internet 126 through communication channel 152. Electronic device 100 can be in communication with Internet 126 in many different ways, such as by operating a web browser, such as SAFARI and OPERA. In this embodiment, Internet 126 is in communication with web application server 121 through communication channel 151. In this embodiment, web application server 121 is in communication with coupon database 130 through communication channel 150. In this embodiment, web application server 121 runs a web application 122, as indicated by an indication arrow 141. In this embodiment, coupon redemption system 120b includes a communication network 127 in communication with Internet 126 and electronic device 100 through communication channels 154 and 155, respectively. In this embodiment, communication network 127 includes a cell tower 128, as indicated by an indication arrow 142. It should be noted that web application 122 can be included with web-based coupon redemption system 120a, which is discussed above with FIG. 2.

In this embodiment, coupon redemption system 120b includes a point of sale system 124 in communication with a bar code reader 125. Bar code reader 125 is capable of reading bar code image 111 displayed by display screen 103 of electronic device 100. As mentioned above, the ability of bar code reader 125 to read bar code image 111 is represented by communication channel 153. In general, communication channel 153 is an optical communication channel because bar code image 111 is typically read with a light signal provided by bar code reader 125, although, in some situations, bar code image 111 can be imaged with a camera. More information regarding communication channel 153 is provided above.

In this embodiment, electronic device 100 operates a local application 123, as indicated by an indication arrow 143. Local application 123 can include many different types of technologies, such as Cell Identification, Enhanced Cell Identification, TDOA (Time difference of arrival), TOA (Time of arrival, AOA (Angle of arrival), E-OTD—(Enhanced Observed Time Difference), A-GPS (Assisted-Global Positioning Services), GPS (Global Positioning Services) and WiFi Identification.

Local application 123 is used to communicate with web application server 121 and coupon database 130 for coupon information. Local application 123 is useful because it allows the use of any Global Position Satellite (GPS) capability of electronic device 100. The GPS capability of electronic device 100 is useful for locating merchants, coupons, and pricing in a desired area. In one situation, electronic device 100 has the capability of determining its Global Positioning System (GPS) coordinates to search for coupons that can be redeemed in a region which includes the GPS coordinates. The region which includes the GPS coordinates can be set by the user, if desired. For example, the user can specify that he or she wants to search for coupons that are redeemable within 5 miles of the GPS coordinates. In another example, the user can specify that he or she wants to search for coupons that are redeemable within 10 miles of the GPS coordinates, wherein local application 123 communicates with web application server 121 and coupon database 130 to locate and identify coupons within the desired area for a given merchant, product, service, etc. In this way, the GPS ability of electronic device 100 can be used to locate softcopies of coupons for desired geographical regions.

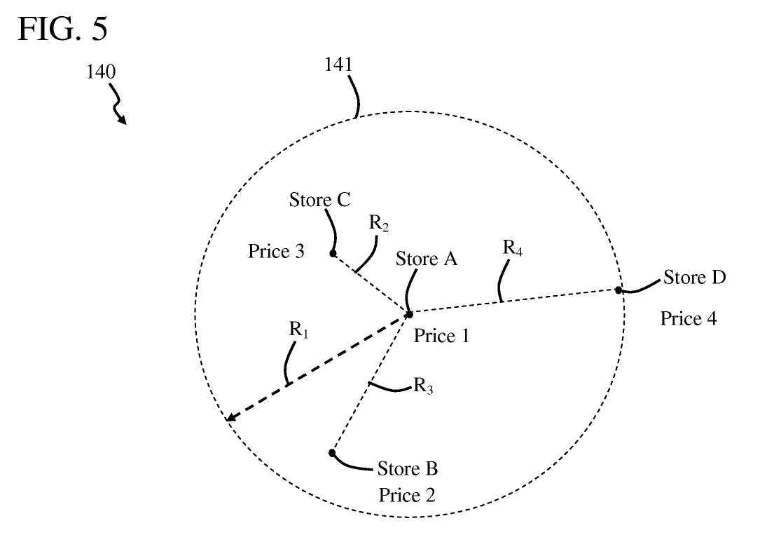

FIG. 4 is a diagram of a local-application based coupon redemption system 120c, in accordance with the invention. In this embodiment, coupon redemption system 120c includes an electronic device 100a in communication with Internet 126 and communication network 127 through communication channels 152a and 155a, respectively. In this embodiment, coupon redemption system 120c includes an electronic device 100b in communication with Internet 126 and communication network 127 through communication channels 152b and 155b, respectively. Electronic devices 100a and 100b can communicate with each other through internet 126 and communication network 127. It should be noted that, in some situations, electronic devices 100a and 100b are the same electronic devices at different geographical locations. In other embodiments, electronic devices 100a and 100b are different electronic devices, which are capable of communicating with each other.

In this embodiment, Internet 126 is in communication with web application server 121 through communication channel 151. In this embodiment, coupon redemption system 120c includes communication network 127 in communication with Internet 126 and electronic device 100 through communication channels 154 and 155a, respectively. In this embodiment, communication network 127 includes cell tower 128, as indicated by indication arrow 142. In this embodiment, communication network 127 includes a Global Positioning System (GPS) 129, as indicated by an indication arrow 144, which is capable of providing GPS data to an electronic device in communication therewith. In this embodiment, coupon redemption system 120c includes point of sale system 124 in communication with bar code reader 125. As discussed above, bar code reader 125 is capable of reading bar code image 111 displayed by display screen 103 of electronic device 100b. It should be noted that, in this embodiment, electronic devices 100a and/or 100b can operate local application 123, if desired, as indicated by indication arrow 143 of FIG. 3.

In this embodiment, web application server 121 operates web application 122, as indicated by indication arrow 141. Further, web application server 121 operates coupon database 130, as well as a Universal Product Code (UPC) database 131 and geographical database 132. It should be noted that, in other embodiments, web application server 121 can be in communication with databases 130, 131 and/or 132 through a communication channel, if desired, as discussed in more detail above with FIGS. 2 and 3. UPC database 131 includes a data base of Universal Produce Codes (UPC) corresponding to particular products. UPC codes are used to track and identify products in a well-known manner. Geographical database 132 includes a database of store locations in various a geographical regions. The store locations can be provided in many different ways, such as the store addresses. A store address typically includes the store's street address, as well as the store's city, state and zip code.

In operation, electronic device 100b acquires an image of bar code 110 using its camera 105, wherein the image of bar code 110 corresponds with a bar code image 111a. Bar code image 111a is displayed by display screen 103 of electronic device 100a. Bar code image 111a is interpreted locally by electronic device 100a by the local application it operates and is converted into an ASCII product code. Electronic device 100a implements a geographic location based positioning function to identify its approximate geographic location. The ability and accuracy of an electronic device to perform geographic locating functions is dependent upon many factors, such as the location of the electronic device, as well as the technologies provided by the electronic device and the communication network it is in communication with.

The product code is transmitted by electronic device 100a through internet 126 and/or communication network 127 to web application server 121. The geographic location information is transmitted by electronic device 100a, through internet 126, and to web application server 121. Web application server 121 correlates the geographic location information of electronic device 100a and resulting scanned product code with the web servers Geographic, UPC, and Coupon Databases to return useful information. The useful information can be of many different types, as will be discussed in more detail presently.

In some embodiments, the useful information corresponds with comparative product pricing for stores in a given geographic location or surrounding distance and/or for online stores. In some embodiments, the useful information corresponds with active electronic coupons for the scanned product filtered for merchants in a specified geographic location or by online retailers/service providers. In these embodiments, the useful information can correspond with active coupons determined by an expiration date and by remaining available uses based on user profile. In some embodiments, the useful information corresponds with the lowest available pricing by factoring in available electronic coupons into the scanned products pricing and filtered by merchants in a given geographic location or by online retailers/service providers. In this way, web application server 121 selects the coupon in response to an indication of the geographical location of electronic device 100.

Electronic device 100a can transmit a query function to web application server 121 for available electronic coupons. The function of searching for, viewing, and redeeming electronic coupons can be performed independently or in conjunction with the product scan function. Electronic coupons can be restricted for use based on coupon expiration date and by remaining available uses based on user profile. The electronic coupon distribution and redemption process follows that of web browser method outlined in the section above with the exception that the local application is interfacing with the web application server rather than the web browser.

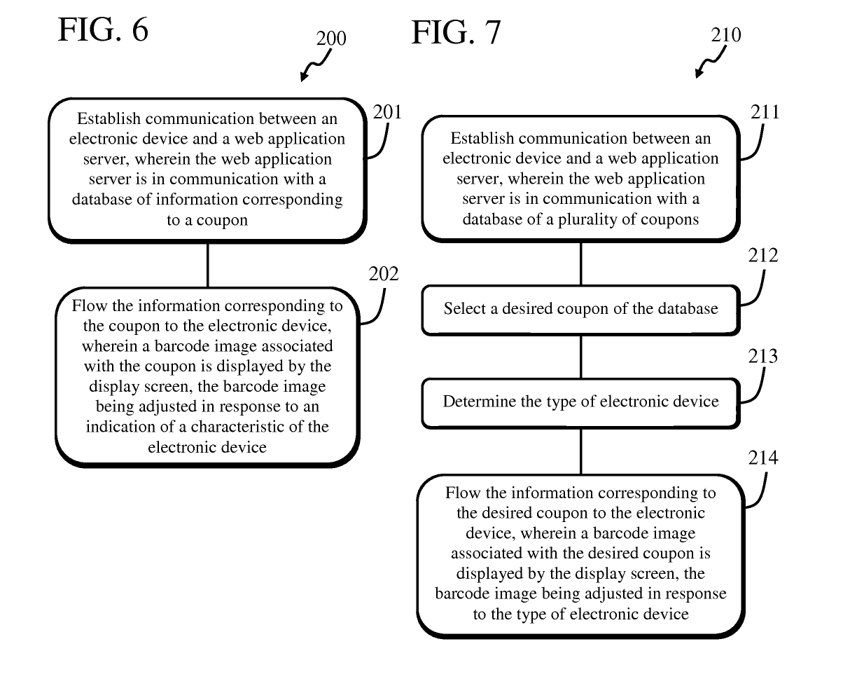

An example of the operation of local-application based coupon redemption system 120c is as follows. The example can be better understood with reference to FIG. 5, which is a diagram 140 of a geographical location 141, which includes a number of stores. A user of electronic device 100 decides that he or she would like to purchase a product, denoted as Product A. The user finds Product A at a store, denoted as Store A. Product A at Store A is available for Price 1. The user uses camera 105 of electronic device 100 (FIG. 1e) to image bar code 110 of Product A so that bar code image 111 is displayed by display screen 103, as discussed in more detail above with FIGS. 1a, 1b, 1c, 1d and 1e. Local Application 123 determines the UPC code which corresponds to Product A.

The user communicates with web server 121 through Internet 126 and/or communication network 127, and the UPC code determined by local application 123 is flowed to web server 121. In this embodiment, web server 121 is in communication with databases 130, 131 and/or 132 through a communication channel, as discussed in more detail above with FIG. 4. Web server 121 receives the UPC code information and determines whether or not the UPC code is stored with UPC database 131. A coupon for the product corresponding to the UPC code information is not stored with coupon database 130 when the UPC code information is not stored with UPC database 131. When the UPC code information is not stored with UPC database 131, a first indication is provided to the user of electronic device 100 by web server 121, wherein the first indication is flowed through Internet 126 and/or communication network 127. The first indication is typically displayed by display screen 103 so that the user can see it. In this way, the user will know that no coupons are available, using local-application based coupon redemption system 120c, to acquire Product A at a lower price.

A coupon for the product corresponding to the UPC code information is stored with coupon database 130 when the UPC code information is stored with UPC database 131. When the UPC code information is stored with UPC database 131, a second indication is provided to the user of electronic device 100 by web server 121, wherein the second indication is flowed through Internet 126 and/or communication network 127. The second indication is typically displayed by display screen 103 so that the user can see it. In this way, the user will know that there are coupons available, using local-application based coupon redemption system 120c, to acquire Product A at a lower price.

Web server 121 can search coupon database 130 in response to a search indication provided by the user of electronic device 100. The search indication is typically flowed between electronic device 100 and web server through Internet 126 and/or communication system 127. The search indication is typically provided to web server 121 in response to electronic device receiving the second indication.

It is desirable to search coupon database 130 for many different reasons, such as to locate other coupons for Product A which can be used at stores other than Store A. The user can specify a particular geographical location, such as a geographical region 141, that he or she wants to search for Product A. In the example of FIG. 5, the user specifies that the search is for stores within a predetermined radius of Store A, wherein the radius is denoted as R₁. Radius R₁ can have many different distance values, such as 1 mile, 5 miles, 10 miles, etc. The values for radius R₁ are typically user specified and flowed to web server 121 by electronic device 100 using Internet 126 and/or communication system 127. Web server 121 determines the stores within geographical region 141 by searching for them in geographical database 132.

In one situation, the search results are flowed by web server 121 to electronic device 100 through Internet 126 and/or communication system 127 so that the search results are displayed by display screen 103. The search results typically include a listing of the stores, such as Store B, Store C and Store D, which are selling Product A, as well as their location and the price of Product A. In this example, Store B, Store C and Store D have Product A available for Price 2, Price 3 and Price 4, respectively. The user can determine from the information, displayed by display screen 103, which store has Product A available for the lowest price. It should be noted that Price 2, Price 3 and Price 4 can be the prices of Product A with and without the coupon value subtracted therefrom. The price of a product less the coupon amount is referred to as the discount price.

The user can determine from the information, displayed by display screen 103, which of the stores within geographical region 141 are the closest in geographical distance. In this example, the geographical distance is relative to Store A. However, it should be noted that the geographical distance can be relative to any geographical location, as desired by the user of electronic device 100. In this example, Store C, Store B and Store D are distances R₂, R₃ and R₄, respectively, from Store A, wherein distance R₂ is less than distance R₃, and distance R₃ is less than distance R₄. Hence, the user of electronic device 100 can determine, using local-application based coupon redemption system 120c a store in a predetermined geographical region which has available a desired product at the lowest price.

The user can select the desired coupon for use at a desired store and, in response web server 121 flows, through Internet 126 and/or communication network 127, the coupon information corresponding with the desired coupon to electronic device 100. Electronic device 100 displays, using display screen 103, the coupon information. Electronic device 100 can display the coupon information in many different ways, such as by displaying its barcode image and/or indicia corresponding to its UPC code. The coupon information is then presented at point of sale system 124 (FIG. 4) and the desired product is purchased. More information regarding displaying coupon information with display screen 103 is provided above with FIGS. 1a, 1b, 1c, 1d and 1e. In some situations, the coupon information displayed by display screen 103 is determined by bar code reader 125, as shown in FIG. 4, through communication channel 153. In some situations, the coupon information displayed by display screen 103 is entered manually into point of sale system 124 (FIG. 4).

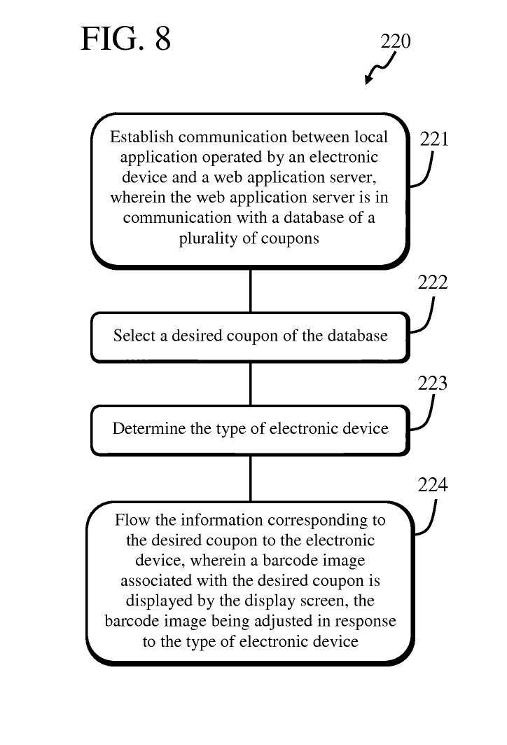

FIG. 6 is a flow diagram of a method 200, in accordance with the invention of displaying an image with a display screen of an electronic device. In this embodiment, method 200 includes a step 201 of establishing communication between the electronic device and a web application server, wherein the web application server is in communication with a database of information corresponding to a coupon. In this embodiment, method 200 includes a step 202 of flowing the information corresponding to the coupon to the electronic device, wherein a barcode image associated with the coupon is displayed by the display screen, the barcode image being adjusted in response to an indication of a characteristic of the electronic device.

Method 200 can provide many features. For example, in some embodiments, the characteristic of the electronic device corresponds to the resolution of its display screen. In some embodiments, the characteristic of the electronic device corresponds to the size of the display screen.

Method 200 can include many other steps. For example, in some embodiments, method 200 can include a step of determining the barcode information with a scanning device. In some embodiments, method 200 can include a step of selecting, with the web application server, the coupon in response to an indication of the geographical location of the electronic device. In some embodiments, method 200 includes a step of adjusting the bar code image in response to driving a dimension of a bar of the bar code image to be equal to or greater than about 3 mils. In some embodiments, method 200 includes adjusting the bar code image in response to driving a dimension of the bar code image to equal a dimension of the display screen.

FIG. 7 is a flow diagram of a method 210, in accordance with the invention of displaying an image with a display screen of an electronic device. In this embodiment, method 210 includes a step 211 of establishing communication between the electronic device and a web application server, wherein the web application server is in communication with a database of a plurality of coupons. In this embodiment, method 210 includes a step 212 of selecting a desired coupon of the database and a step 213 of determining the type of electronic device. In this embodiment, method 210 includes a step 214 of flowing the information corresponding to the desired coupon to the electronic device, wherein a barcode image associated with the desired coupon is displayed by the display screen. The barcode image is adjusted in response to the type of electronic device.

Method 210 can provide many features. For example, in some embodiments, the characteristic of the display screen is the resolution of the display screen. In some embodiments, the characteristic of the display screen is the size of the display screen.

Method 210 can include many other steps. For example, in some embodiments, method 210 includes a step of operating a local application with the electronic device, wherein the local application communicates with the web application and database server for coupon information. In some embodiments, the step of selecting the desired coupon includes determining the geographical location of the electronic device. In some embodiments, the step of determining the geographical location of the electronic device includes using a Global Positioning System (GPS). In some embodiments, the step of determining the type of electronic device includes determining a characteristic of its display screen.

FIG. 8 is a flow diagram of a method 220, in accordance with the invention of displaying an image with a display screen of an electronic device. In this embodiment, method 220 includes a step 211 of establishing communication between a local application operated by the electronic device and a web application server. The web application server is in communication with a database of a plurality of coupons. In this embodiment, method 210 includes a step 212 of selecting a desired coupon of the database and a step 213 of determining the type of electronic device. In this embodiment, method 210 includes a step 214 of flowing the information corresponding to the desired coupon to the electronic device, wherein a barcode image associated with the desired coupon is displayed by the display screen. The barcode image is adjusted in response to the type of electronic device.

In this embodiment, the local application functionality supersedes the web application functionality as it includes the ability to scan products, perform product price comparisons, and correlate coupons with scanned products to identify the most inexpensive pricing option while web browser functionality requires a more manual approach of looking up coupons for redemption and does not offer product scanning, or price comparison functionality. The local application makes use of an onboard or external camera as well as any available location based service technologies or built in GPS technologies to ingrate product scanning and location based awareness functionality into the coupon and product requests made by a user where web browser access does not support these capabilities. Further, the electronic coupon redemption method remains the same regardless if the electronic coupon is being presented to a user through a web browser or local application.

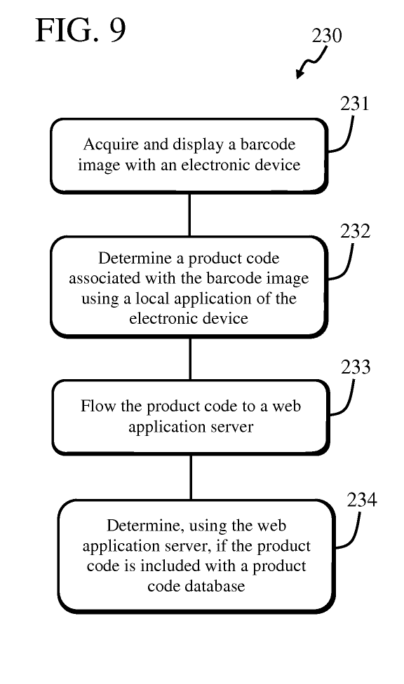

FIG. 9 is a method 230, in accordance with the invention, of determining a store in which a coupon is redeemable. In this embodiment, method 230 includes a step 231 of acquiring and displaying a barcode image with an electronic device. Method 230 includes a step 232 of determining a product code associated with the barcode image using a local application of the electronic device. Method 230 includes a step 233 of flowing the product code to a web application server. Method 230 includes a step 234 of determining, using the web application server, if the product code is included with a product code database.

Method 230 can include many other steps. For example, in some embodiments, method 230 includes a step of the web application server providing an indication to the electronic device if the product code is not included with the product code database. In these embodiments, the electronic device typically displays an image corresponding to the indication so that the user of the electronic device will know that the product code is not included with the product code database.

In some embodiments, method 230 includes a step of the web application server determining if a coupon is included with a coupon database in response to an indication that the product code is included with the product code database. The web application server can determine if a coupon is included with a coupon database in many different ways, such as by searching the database.

In some embodiments, method 230 includes a step of flowing to the electronic device, using the web application server, a barcode image associated with the coupon, wherein the coupon barcode image is displayed by the electronic device. The coupon barcode image is typically displayed by a display screen of the electronic device. The coupon barcode image is displayed by the electronic device so that it can be scanned by a bar code reader. The coupon bar code image can be adjusted in response to driving a dimension of a bar of the coupon bar code image to be between about 3 mils to about 15 mils. In general, a dimension of a bar of the coupon bar code image is driven to be equal to or greater than about 3 mils.

In some embodiments, method 230 includes a step of the local application determining the geographical location of the electronic device, and flowing the geographical location to the web application server. The geographical location of the electronic device can be determined in many different ways, such as by using a GPS system and by using triangulation of cell towers.

In some embodiments, method 230 includes a step of the web application server searching a geographical database for a store which provides a product corresponding with the product code, wherein the store is within a predetermined distance of the geographical location of the electronic device. The predetermined distance is typically chosen by the user of the electronic device, and flowed to the web application server by the electronic device.

In some embodiments, method 230 includes a step of the web application server flowing to the electronic device information regarding the store, wherein the store information is displayed by the electronic device. The store information can be of many different types, such as the store address as well as the price of the product corresponding with the product code.

It should be noted that, in some situations, store information corresponding to more than one store is found by the web application server when searching the geographical database. The locations of these stores are generally within the predetermined distance from the geographical location of the electronic device. In these situations, the information corresponding to the stores within the predetermined distance from the geographical location of the electronic device is displayed by the electronic device.

In some embodiments, method 230 includes a step of the local application determining which store within the predetermined distance from the geographical location of the electronic device provides the product corresponding with the product code at a desired price.

In some embodiments, method 230 includes a step of the local application determining which store within the predetermined distance from the geographical location of the electronic device provides the product corresponding with the product code at a desired discount price. As mentioned above, the desired discount price is the price of the product less the value of the corresponding coupon of the coupon database.

The embodiments of the invention described herein are exemplary and numerous modifications, variations and rearrangements can be readily envisioned to achieve substantially equivalent results, all of which are intended to be embraced within the spirit and scope of the invention.

1. A coupon redemption system, comprising:
a web application server having a database corresponding with information regarding a coupon;
a data communication network; and
an electronic device in communication with the web application server through the data communication network, wherein the electronic device displays a barcode image corresponding to the coupon information, the bar code image being adjustable in response to an indication of the type of electronic device.

2. The system of claim 1, wherein the bar code image is adjustable in response to a display resolution of the electronic device.

3. The system of claim 1, wherein the bar code image is adjustable in response to a screen size of the electronic device.

4. The system of claim 1, wherein a dimension of a bar of the bar code image is driven to be equal to or greater than about 3 mils.

5. The system of claim 1, wherein a dimension of the bar code image is driven to equal a dimension of a display screen of the electronic device.

6. The system of claim 1, wherein the web application server selects the coupon in response to an indication of the geographical location of the electronic device.

7. A method of displaying an image with a display screen of an electronic device, comprising:
establishing communication between the electronic device and a web application server, wherein the web application server is in communication with a database of information corresponding to a coupon; and
flowing the information corresponding to the coupon to the electronic device, wherein a barcode image associated with the coupon is displayed by the display screen, the barcode image being adjusted in response to an indication of a characteristic of the electronic device.

8. The method of claim 7, further including determining the barcode information with a scanning device.

9. The method of claim 7, further including selecting the coupon with the web application server in response to an indication of the geographical location of the electronic device.

10. The method of claim 7, wherein the characteristic of the electronic device corresponds to the resolution of its display screen.

11. The method of claim 7, wherein the characteristic of the electronic device corresponds to the size of the display screen.

12. The method of claim 7, wherein the bar code image is adjusted in response to driving a dimension of a bar of the bar code image to be greater than or equal to about 3 mils.

13. The method of claim 7, wherein the bar code image is adjusted in response to driving a dimension of the bar code image to equal a dimension of the display screen.

14. A method, comprising:
acquiring and displaying a barcode image with an electronic device;
determining a product code associated with the barcode image using a local application of the electronic device;
flowing the product code to a web application server; and
determining, using the web application server, if the product code is included with a product code database.

15. The method of claim 14, wherein the web application server provides an indication to the electronic device if the product code is not included with the product code database.

16. The method of claim 14, wherein the web application server determines if a coupon is included with a coupon database in response to an indication that the product code is included with the product code database.

17. The method of claim 16, further including flowing to the electronic device, using the web application server, a barcode image associated with the coupon, wherein the coupon barcode image is displayed by the electronic device.

18. The method of claim 17, wherein the local application determines the geographical location of the electronic device, and flows the geographical location to the web application server.

19. The method of claim 18, wherein the web application server searches a geographical database for a store which provides a product corresponding with the product code, wherein the store is within a predetermined distance of the geographical location.

20. The method of claim 19, wherein the web application server flows to the electronic device information regarding the store, wherein the store information is displayed by the electronic device.

21. A coupon redemption system, comprising:
a web application server having a database corresponding with information regarding a plurality of coupons;
a data communication network; and
an electronic device in communication with the web application server through the data communication network, wherein the web application server selects a coupon from the plurality of coupons in response to a bar code image acquired by the electronic device.

22. The system of claim 21, wherein the electronic device adjusts the bar code image in response to an indication of the type of electronic device.

23. The system of claim 21, wherein the web application server selects the coupon in response to an indication of the geographical location of the electronic device.

24. The system of claim 21, wherein search results are displayed by the electronic device in response to a search indication provided to the web application server.

25. The system of claim 24, wherein the search results include selected coupons of the plurality of coupons.

26. The system of claim 25, wherein the coupons are selected in response to an indication of the geographical location of the electronic device.

27. The system of claim 24, wherein the search results include at least one of a price, discount price and a store location.
